(19) United States
(12) Patent Application Publication
(10) Pub. No.: US 2007/0251798 A1
(43) Pub. Date: Nov. 1, 2007

(54) Money-Operated Machine and Method for Servicing It

(76) Inventors: Kenneth Aubrey, Munich (DE); Erwin Braukmann, Wolfratshausen (DE)

Correspondence Address: HARNESS, DICKEY & PIERCE, P.L.C., P.O.BOX 8910, RESTON, VA, 20195, US

(21) Appl. No.: 10/581,489

(22) PCT Filed: Nov. 25, 2004
(86) PCT No.: PCT/EP04/53092

§ 371 Date: Mar. 13, 2007

(30) Foreign Application Priority Data
Dec. 3, 2003 (DE) 10356872.7

(51) Int. Cl. G07F 9/00

(52) U.S. Cl. 194/205; 194/350

(57) ABSTRACT

A money-operated machine is disclosed, such as a ticket machine for parking, for example. The machine includes a changeable cashbox used to receive money, which can be changed at given time intervals. The machine further includes a rechargeable voltage source for supplying the electric consumers of the machine with power. A method is disclosed for maintaining the money-operated machine. By integrating the voltage source into the cashbox, it is possible to form a common change unit. As a result, the money-operated machine requires less servicing since the cashbox can be changed and the voltage source can be charged in a single work step.

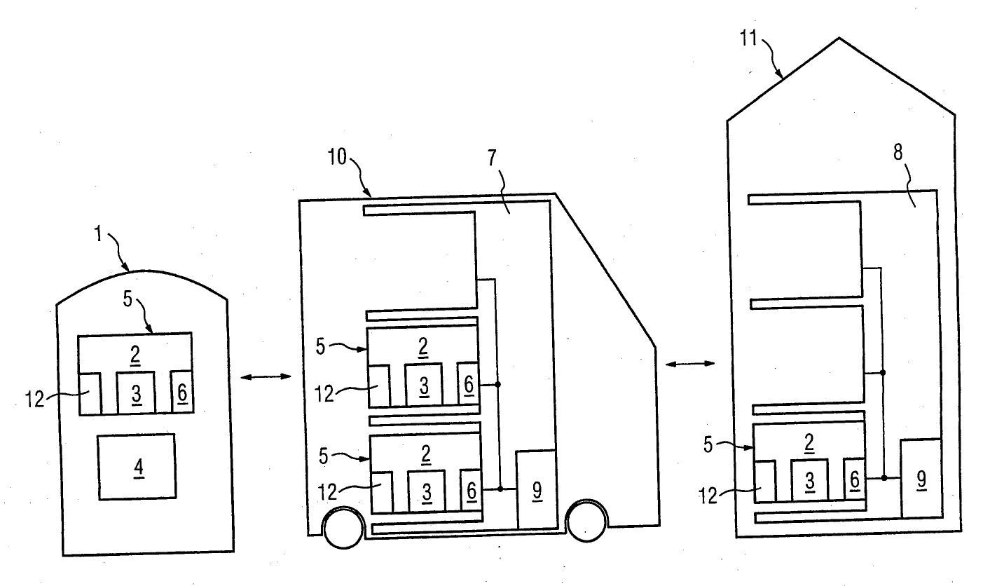

This application is the national phase under 35 U.S.C. § 371 of PCT International Application No. PCT/DE2004/053092 which has an International filing date of Nov. 25, 2004, which designated the United States of America and which claims priority on German Patent Application number 103 56 872.7 filed Dec. 3, 2003, the entire contents of which are hereby incorporated herein by reference.

### FIELD

The invention generally relates to a money-operated machine and to a method for servicing such a machine.

### BACKGROUND

Money-operated machines are used as parking-ticket machines but also as cigarette machines, stamp machines, ticket machines, snack machines for example, as well as other comparable machines with low power consumption.

German product specification “SITRAFFIC SITY 5”, published by Siemens AG under order number E10003-A800-W19, discloses a parking-ticket machine from which parking tickets can be obtained using coins, as well as other forms of payment, with the coins being held in a coin box. This coin box is in the form of a replaceable cashbox which—before it can no longer hold any more money—regularly needs to be exchanged for an empty cashbox.

Different versions are provided in order to supply power to electrical loads of the parking-ticket machine, for example controllers with microprocessors and data storage device(s), paper-printing and cutting apparatuses, coin-slot barrier and checking device(s), LCD displays and operator control elements. In addition to a solar version with a solar module and storage battery (called battery for short in the text which follows) and a lamp version in which the machine is connected to the power supply means of a nearby street lamp, a purely battery-operated version is known, in which empty batteries have to be exchanged for full batteries at specific intervals.

European patent application EP 0 692 599 A1 discloses a system for securely transporting articles. The system has a storage station in an office and a deposit station in a bank, which stations both have a modem for communicating with one another.

The modems are connected to computers and these are in turn connected to docking stations which can receive an “intelligent” security container. The upper face of a docking station forms a bearing surface for a cartridge from which bank notes or checks can be drawn into the docking station. The electrical circuit of a docking station includes a power supply unit which is connected to an AC voltage source or an internal battery during operation and supplies power to the electronic circuits. The power supply unit is also connected to a battery-charging connection for charging an internal battery of the security container.

However, this known machine requires a considerable amount of servicing outlay for technical maintenance, replacing paper and the cashbox, and changing the battery.

### SUMMARY

At least one embodiment of the invention includes an object of providing a money-operated machine which requires less servicing, and/or a method for servicing a machine of this type.

According to at least one embodiment of the invention, a first part of the object may be achieved by a money-operated machine. Since the voltage source is integrated in the cashbox in such a way that they form a common replacement unit, the voltage source is automatically replaced each time the cashbox is replaced, so that the machine is always guaranteed to be supplied with power. The new cashbox has a charged voltage source, so that it is not necessary to replace rechargeable voltage sources, for example battery devices, in a separate operation. This provides a cost-effective solution for supplying power to a money-operated machine along with correspondingly low outlay on servicing.

According to at least one embodiment of the invention, the replacement unit has an interface via which the voltage source can be connected to electrical loads when the replacement unit is positioned in the machine. The interface has, for example, contacts, preferably plug contacts, via which the voltage source can be electrically connected to the power consumers in the machine when the replacement unit is positioned in said machine. Contact can therefore be interrupted or made between electrical loads and the voltage source which is integrated in the replacement unit by simply removing or inserting the replacement unit.

In one example embodiment of the invention, the interface is designed in such a way that the voltage source can be connected to a charging station via said interface when the replacement unit is positioned in a holding frame which is arranged outside the machine. Therefore, when the replacement unit is exchanged, the voltage source can be connected to a charging station for charging purposes via the same interface via which the voltage source supplies power to the electrical loads in the machine, when the replacement unit is positioned in a holding frame which is arranged outside the machine. In this case, contact is made just as simply via the interface as in the machine itself.

The replacement unit is, in at least one embodiment for example, intended to be held in a transportation frame which is arranged in a transportation vehicle and has a charging station, so that the voltage source is recharged even during transportation of a cashbox, which has been exchanged, in a transportation vehicle which is used in practice to regularly take away machines belonging to a machine operator for refilling or maintenance purposes.

As an alternative or in addition to this, in at least one embodiment for example, the replacement unit is intended to be held in a storage frame which has a charging station and is arranged at a cashbox-emptying location or at a charging location. As a result, the voltage source which is integrated in the cashbox can be charged at the place where the full cashboxes which have been collected are discharged from the transportation vehicle in order to be emptied, or at any other charging location at which especially the voltage sources can be recharged.

In this case, the storage frame with a charging station may be designed in the same way as the transportation frame in the transportation vehicle. The cashbox-emptying locations used may be service centers or else financial institutions, such as banks, directly. The charging locations used may be special stations with a power supply connection for feeding charging devices.

In one further advantageous refinement of at least one embodiment of the invention, at least one display is provided for displaying the charge state of the voltage source. The display can be arranged on the replacement unit or on the storage frame. However, it is also possible to use at least one display, for example on the housing of the machine, which is present on the machine in any case and provided to display other information.

Maintenance personnel use the display(s), which may be formed by light-emitting diodes or liquid-crystal displays for example, to establish whether a replacement unit which is located in a storage frame has a charged voltage source or a voltage source which is still being charged. As a result, a replacement unit with a fully charged voltage source can be reinserted into a machine, while other replacement units remain in the storage frame until they reach the full charge state.

Another part of the object, on which at least one embodiment of the invention is based, may be achieved by a method for servicing a money-operated machine. This servicing method, in particular for replacing the cashbox and for charging the voltage source, proposes exchanging, at prespecified intervals, a replacement unit of the machine, which unit is to be exchanged and has a cashbox which needs to be emptied and/or a voltage source which needs to be charged, for a new replacement unit which has an empty cashbox and a charged voltage source.

In this case, a new replacement unit may be prepared in a holding frame with a charging station in which the voltage source is charged, with the holding frame being arranged in a transportation vehicle and/or at a cashbox-emptying location and/or at a special charging location. This renders separate servicing runs for replacing the cashbox and exchanging the voltage source superfluous since these can both be performed in a single operation.

### BRIEF DESCRIPTION OF THE DRAWINGS

Further advantages of the invention can be found in the following explanation of the drawing whose single FIGURE schematically illustrates an embodiment of an inventive money-operated machine and a method for servicing it.

The FIGURE shows a money-operated machine 1, for example a parking-ticket machine.

### DETAILED DESCRIPTION OF THE EXAMPLE EMBODIMENTS

The FIGURE shows a money-operated machine 1, for example a parking-ticket machine, which has a cashbox 2 for holding money. The cashbox 2 needs to be emptied at prespecified intervals in order to be able, at all times, to hold money which is inserted into the machine. To this end, the cashbox 2 is designed to be exchangeable, so that it can be exchanged for a physically identical, empty cashbox 2 from time to time.

The machine 1 also has a voltage source 3 for supplying power to electrical loads 4 which are required for operation of the machine 1. In this case, the voltage source 3 is rechargeable, that is to say is in the form of a storage battery, for example. If, after a certain period of time, the charge state of the voltage source 3 has fallen below a certain value, the voltage source 3 has to be recharged.

According to at least one embodiment of the invention, the voltage source 3 is now integrated in the cashbox 2 in such a way that they form a common replacement unit 5. The replacement unit 5 has an interface 6 via which the voltage source 3 can be connected to electrical loads 4 when the replacement unit 5 is positioned in the machine 1. The connection between the interface 6 of the replacement unit 5 and the electrical loads 4, of which only one—for example a controller of the machine 1 with a processor unit and a data storage means—is illustrated for the sake of simplicity but a plurality of electrical loads is indicated by the dots, is illustrated by lines which represent electrical cables.

The voltage source 3 can be connected to a charging station 9 of a holding frame by the same interface 6. The holding frame may be in the form of a transportation frame 7 which is arranged in a transportation vehicle 10.

The transportation frame 7 which is illustrated in the FIGURE includes a large number of holding compartments for replacement units 5, in which compartments an electrical connection is produced between the voltage source 3 and the charging station 9 via the interface 6, so that the voltage source 3 can be charged during transportation. On its service run, a transportation vehicle 10 visits a plurality of machines 1 which require attention and in the process exchanges replacement units 5 with full cashboxes 2 and/or empty voltage sources 3 for new replacement units 5 with empty cashboxes 2 and charged voltage sources 3.

At the end of the run, the replacement units 5 which have been collected are taken to a cashbox-emptying location 11, for example a service center or a financial institution, where the cashboxes 2 are completely emptied. After the money is removed, the replacement units 5 are prepared in a storage frame 8 where the voltage sources 3 are charged further by being connected to a charging station 9 via the interface 6.

One further possible option, which is not illustrated here, is to arrange the storage frame 8 at a charging location which is visited especially for this purpose. The empty transportation vehicle 10 takes new replacement units 5 from the storage frame 8 for the next service run. The cashboxes 2 of the replacement units 5 in the storage frame 8 are empty, while the charge state of the voltage source 3 can be seen via display 12. As a result, service personnel can see which replacement units 5 have sufficiently charged voltage sources 3 which are therefore again ready for use in machines 1 according to the invention.

The display 12 can also be arranged on the storage frame 8 for this purpose. However, as an alternative, a display—for example on the housing of the machine—which is already present on the machine and provided to display other information can also be used as the display 12. Finally, it is, however, also possible to only initially test the charge state in the machine 1 when replacing the replacement unit 5, in order to make a cost saving.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A money-operated machine, comprising:
a replaceable cashbox to hold money, replaceable at specified intervals; and
a rechargeable voltage source to supply power to electrical loads of the machine, the voltage source being integrated in the cashbox to form a common replacement unit, the replacement unit including an interface via which the voltage source is connectable to the electrical loads of the machine when the replacement unit is positioned in the machine.

2. The machine as claimed in claim 1, wherein the voltage source is connectable to a charging station via said interface when the replacement unit is positioned in a holding frame arranged outside the machine.

3. The machine as claimed in claim 2, wherein the replacement unit is holdable in a transportation frame, arranged in a transportation vehicle, and includes a charging station.

4. The machine as claimed in claim 2, wherein the replacement unit is holdable in a storage frame, including a charging station and arranged at least one of a cashbox-emptying location and at a charging location.

5. The machine as claimed in claim 1, further comprising at least one display to display a charge state of the voltage source.

6. A method for servicing a money-operated machine, as claimed in claim 1, with a replacement unit of the machine, the replacement unit, being exchangeable and including at least one of a cashbox to be emptied and a voltage source to be charged, the method comprising:
exchanging the replacement unit at specified intervals for a new replacement unit, the new replacement unit being prepared in a holding frame, with a charging station in which the voltage source is charged, and the holding frame being arranged at least one of in a transportation vehicle and at at least one of a cashbox-emptying location and at a charging location.

7. (canceled)

8. The machine of claim 1, wherein the money-operated machine is a parking-ticket machine.

9. The machine as claimed in claim 3, wherein the replacement unit is holdable in a storage frame, including a charging station and arranged at least one of a cashbox-emptying location and at a charging location.

10. A method for servicing a money-operated machine with a replacement unit of the machine, the method comprising:
exchanging the replacement unit at specified intervals for a new replacement unit including at least one of a cashbox to be emptied and a voltage source to be charged, the new replacement unit being arranged in a holding frame and the holding frame being arranged at least one of in a transportation vehicle and at least one of a cashbox-emptying location and at a charging location.

11. The method of claim 10, wherein the money-operated machine is a parking-ticket machine.

12. A money-operated machine, comprising:
a cashbox, replaceable at specified intervals; and
a rechargeable voltage source, to supply power to the machine, the voltage source being and the cashbox being an integrated unit, the integrated unit including an interface to connect to the electrical loads of the machine when the integrated unit is positioned in the machine.

13. The machine as claimed in claim 12, wherein the voltage source is connectable to a charging station via said interface when the replacement unit is positioned in a holding frame arranged outside the machine.

14. The machine as claimed in claim 13, wherein the replacement unit is holdable in a transportation frame, arranged in a transportation vehicle, and includes a charging station.

15. The machine as claimed in claim 13, wherein the replacement unit is holdable in a storage frame, including a charging station and arranged at least one of a cashbox-emptying location and at a charging location.

16. The machine as claimed in claim 12, further comprising at least one display to display a charge state of the voltage source.

17. The machine of claim 12, wherein the money-operated machine is a parking-ticket machine.
